(19) United States
(12) Patent Application Publication
(10) Pub. No.: US 2011/0274298 A1
(43) Pub. Date: Nov. 10, 2011

(54) MEMS MICROPHONE

(76) Inventor: Bin YANG, Shenzhen (CN)

(21) Appl. No.: 12/978,585

(22) Filed: Dec. 26, 2010

(30) Foreign Application Priority Data
May 4, 2010 (CN) 201010167950.5

(51) Int. Cl. H04R 11/04

(52) U.S. Cl. 381/174

(57) ABSTRACT

A MEMS microphone includes a silicon substrate defining an opening, a diaphragm being supported above the substrate and a backplate opposite from the diaphragm for forming a capacitor together with the diaphragm. The diaphragm includes a central vibrating portion and a plurality of serpentine segments extending from an edge of the vibrating portion. Each of the serpentine segments includes a first spring and a second spring symmetric to the first spring about an axis extending from a center of the vibrating portion. Each spring includes a first end connecting to the edge of the vibrating portion, a bending portion and a second end extending from the bending portion for anchoring the diaphragm to the substrate. The bending portion extends along a path having the same outline as that of the vibrating portion.

### FIELD OF THE INVENTION

The present invention relates to MEMS (micro-electro-mechanical system) components, and more particularly, to a MEMS microphone having a diaphragm.

### BACKGROUND OF THE INVENTION

Silicon based capacitive transducers, such as MEMS microphones, are well known in the art. Silicon condenser microphones are widely used in mobile phones to receive and convert sound waves into electrical signals. Typically, such a microphone generally comprises a silicon substrate, a backplate arranged on the substrate, and a moveable diaphragm separated from the backplate for forming a capacitor.

When the diaphragm is actuated to vibrate relative to the backplate by sound pressure of voice waves, a distance from the diaphragm to the backplate is changed, and as a result, the capacitance value of the capacitor is accordingly changed, by which voice waves are converted into electrical signals. A diaphragm of a traditional MEMS microphone includes a central movable portion and a periphery extending from the central movable portion. For positioning the diaphragm onto the substrate, the periphery is anchored to the substrate. While sound waves reach the diaphragm, the central movable portion moves. However, movement of the diaphragm is restricted in a limited range by the periphery. Further, the periphery occupies much space of the diaphragm. In addition, middle part of the central movable portion will be distorted because of the periphery anchored to the substrate, which affects the sensitivity of the microphone.

### BRIEF DESCRIPTION OF THE DRAWINGS

FIG. 1 is a cross-sectional view of a microphone in accordance with an exemplary embodiment of the present invention;

FIG. 2 is a top view of a diaphragm used in the microphone in FIG. 1.

### DETAILED DESCRIPTION OF EMBODIMENT OF THE INVENTION

Reference will now be made to describe the embodiment of the present invention in detail.

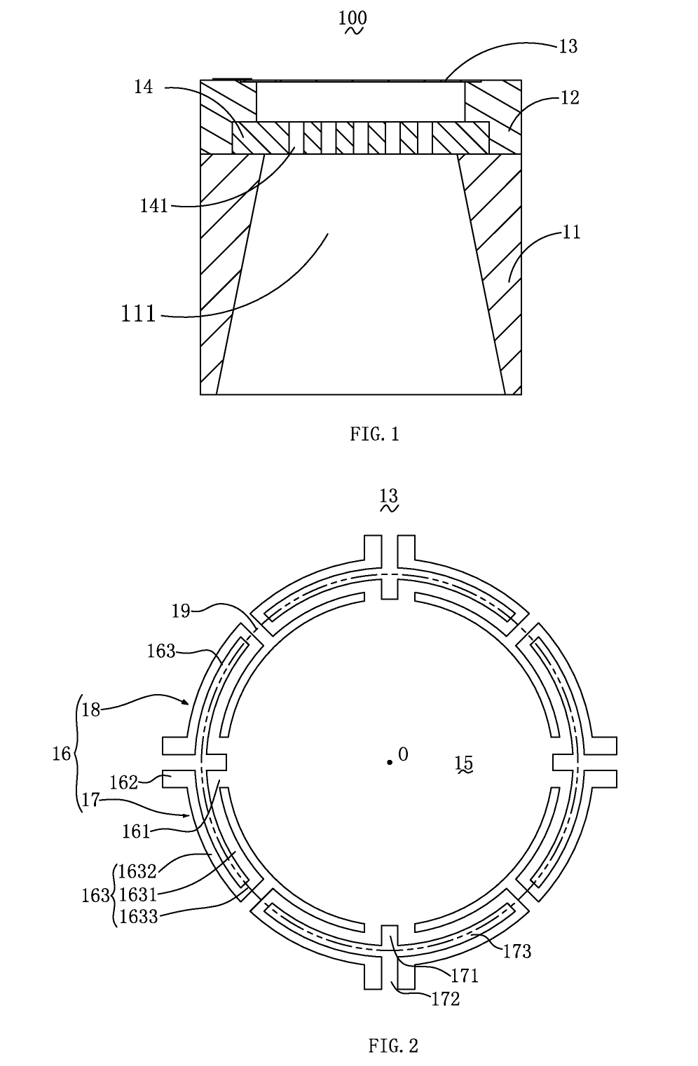

Referring to FIG. 1, a silicon condenser microphone 100, in accordance with an exemplary embodiment of the present invention, comprises a silicon substrate 11 defines an opening 111 therein, a support 12 disposed above the substrate 11, a diaphragm 13 supported by the support 12, and a backplate 14 opposite from the diaphragm 13. The backplate 14 includes a plurality of holes 141 in a central portion thereof and forms a capacitor together with the diaphragm 13. When the diaphragm 12 is actuated to vibrate by sound pressure of external acoustic waves, a distance from the diaphragm 13 to the backplate 14 is changed, which leads into variable capacitance values and variable electrical signals.

Referring to FIG. 2, the diaphragm 13 includes a circular vibrating portion 15 and a plurality of serpentine segments 16 from an edge of the vibrating portion 15. FIG. 2 illustrates a diaphragm with four serpentine segments 16, but, the amount of the serpentine segments is not limited to four. Each of the serpentine segments 16 includes a first spring 17 and a second spring 18 symmetrical to the first spring about an axis extending from the center O of the vibrating portion 15. The spring 17 includes a first end 161 extending from the edge of the vibrating portion 15, a second end 162 anchored to the support 12, and a bending portion 163 extending between the first end 161 and the second end 162. The bending portion 163 is configured to be a part of a virtual circle 19 having a common center O with the vibrating portion 15. The bending portion 163 includes a first arm 1631 extending from the first end 161 along a first direction, a second arm 1632 extending toward the second end 162 along a second direction opposed to the first direction, and a connecting arm 1633 connecting the first arm 1631 with the second arms 1632 at an distal end of the first arm 1631 and a start of the second arm 1632. Preferably, the first arm 1631, the second arm 1632 and the diaphragm 13 are concentric to each other. A shape of the bending portion 163 is approximately U-shape. As the second spring 18 is symmetrical to the first spring 17 about the axis extending from the center O of the vibrating portion 15, the second spring 18 is same to the first spring 17. Accordingly, the serpentine segment 16 is provided with a first gap 171 formed between the two first ends of the first spring 17 and the second spring 18, a second gap 172 formed between the two second ends of the first spring 17 and second spring 18, and a third gap 173 formed between the first arm 1631 and the second arm 1632. The vibrating portion 13 is thus suspended by serpentine segments 16 and is capable of vibrating along a direction perpendicular to the substrate 11. Accordingly, the serpentine segments 16 are obviously lengthened and are provided with perfect elasticity, which effectively improves the sensitivity of the microphone.

In brief, disclosures of the present invention provide silicon condenser microphones including diaphragms defining central vibrating portions and linking portions extending from the vibrating portions along a path having the same outlines as that of the vibrating portions.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A MEMS microphone comprising:
a silicon substrate defining an opening;
a diaphragm being supported above the substrate, the diaphragm including a central vibrating portion and a plurality of serpentine segments extending from an edge of the vibrating portion;
a backplate opposite from the diaphragm for forming a capacitor together with the diaphragm; wherein
each of the serpentine segments includes a first spring and a second spring symmetric to the first spring about an axis extending from a center of the vibrating portion, and each spring includes a first end connecting to the edge of the vibrating portion, a bending portion and a second end extending from the bending portion for anchoring the diaphragm to the substrate, the bending portion extending along a path having the same outline as that of the vibrating portion.

2. The MEMS microphone as described in claim 1, wherein each of the bending portion includes a first arm extending from the first end, a second arm extending to the second end, and a connecting arm connecting the first arm with the second arm at a distal end of the first arm and at a start of the second arm.

3. The MEMS microphone as described in claim 1, wherein the bending portion extends along a path concentric to the vibrating portion.

4. The MEMS microphone as described in claim 3, wherein each of the first arm and the second arm is concentric to the vibrating portion.

5. The MEMS microphone as described in claim 2, wherein each of the serpentine segments includes a first gap formed between the two first ends of the first spring and the second spring, a second gap formed between the two second ends of the first spring and the second spring, and a third gap formed between the first arm and the second arm.

6. A diaphragm for a MEMS microphone, comprising:
a central vibrating portion;
a plurality of linking portions supporting the central vibrating portion, each of the linking portions including a first end connecting to the central vibrating portion, a bending portion extending from the first end, and a second end extending from the bending portion; wherein
the first end defines a first gap for dividing the first end into two parts, the second end defines a second gap for dividing the second end into two parts, and the bending portion defines a third gap communicating with the first and second gaps.

7. The diaphragm as described in claim 6, wherein the bending portion extending a long a virtual circle concentric to the central vibrating portion.

8. The diaphragm as described in claim 7, the bending portion is symmetrical about an axis extending from a center of the central vibrating portion.
